(19) United States
(12) Patent Application Publication
(10) Pub. No.: US 2026/0336456 A1
(43) Pub. Date: Oct. 29, 2026

(54) OPERATION SYSTEM FOR ROBOTIC TRANSPORT VEHICLE AND CONTROL METHOD THEREOF

(71) Applicant: KKUN, Jeonbuk-do (KR)

(72) Inventors: DONG HEE KANG, Seoul (KR); BYEONG CHAN SIM, Seoul (KR)

(21) Appl. No.: 19/465,053

(22) Filed: Jan. 30, 2026

(30) Foreign Application Priority Data
Apr. 28, 2025 (KR) 10-2025-0055057

(51) Int. Cl. B60L 53/65; G06Q 10/08; G06Q 10/083; G06Q 10/0833; G06Q 10/087

(52) U.S. Cl. CPC B60L 53/65; G06Q 10/08; G06Q 10/0833; G06Q 10/08355; G06Q 10/087

(57) ABSTRACT

An operation system for a robotic transport vehicle includes robotic transport vehicles to transmit global positioning system (GPS) information, charging stations to transmit current status information of charging stations, a user terminal device to display delivery order-related information, and a server to generate location information of each robotic transport vehicle and usage status information of each charging station based on the GPS and current status information of the charging stations, respectively, generate selectable delivery order-related information among the delivery order-related information based on at least one of the generated location information and the usage status information, and transmit, to the user terminal device, the generated location information, the usage status information, and the selectable delivery order-related information to be displayed on the user terminal device.

### CROSS-REFERENCE TO RELATED APPLICATION AND CLAIM OF PRIORITY

This application claims the benefit under 35 USC §119 of Korean Patent Application No. 10-2025-0055057, filed on April 28, 2025, in the Korean Intellectual Property Office, the entire disclosure of which is incorporated herein by reference for all purposes.

### BACKGROUND

### 1. FIELD

Apparatuses and methods consistent with the disclosure relate to an operation system for a robotic transport vehicle and a control method thereof, and more particularly, an operation system for a robotic transport vehicle capable of integratively managing a current location of a vehicle, information on surrounding charging stations, and delivery order information, and a control method thereof.

### 2. DESCRIPTION OF THE RELATED ART

In recent years, as demand for electric vehicles and online order-based delivery services has rapidly increased, importance of vehicle location tracking and order status management systems has been increasing across the overall logistics industry.

In particular, along with expansion of distribution of electric vehicles and increased interest in charging infrastructure, accessibility of charging stations for a vehicle during transport and efficient management of charging routes have emerged as new challenges.

In addition, as the transport field and robotic systems are converging, development of transport systems using an autonomous-drivable robotic transport vehicle is increasing.

In this regard, most of conventional vehicle location tracking systems are limited to simply displaying a real-time global positioning system (GPS) location of a vehicle on a map, and some systems provide only a route guidance function or a simple destination setting function. In addition, for a vehicle performing order delivery, an inconvenience may occur in that checking a status of delivery orders, accepting and processing orders, and searching for electric vehicle charging stations have to be performed in a distributed manner through separate applications or systems.

[7] Such a distributed information provision method may not only degrade management efficiency, but also make an immediate response based on a real-time situation difficult. In particular, for an electric vehicle requiring charging during delivery, absence of a system capable of intuitively checking information such as a location of the nearest charging station, charging availability, and a fault status based on a current location may cause significant inconvenience.

[8] Meanwhile, map-based systems are evolving in a direction of visualizing various objects (e.g., vehicles, charging stations, or order information) through continuous technological development. However, technological development regarding a method for integratively managing and displaying a plurality of data is still insufficient.

[9] Accordingly, a need is emerging for an integrated transport management system capable of checking charging station information in real time during driving and simultaneously efficiently managing order information in an automated robotic transport system.

### SUMMARY

The disclosure provides an operation system for a robotic transport vehicle capable of integratively managing a current location of a vehicle, information on surrounding charging stations, and delivery order information, and a control method thereof.

According to an embodiment of the disclosure, provided is an operation system for a robotic transport vehicle, the system including: a plurality of robotic transport vehicles configured to transmit global positioning system (GPS) information; a plurality of charging stations configured to transmit current status information of charging stations; a user terminal device configured to display delivery order-related information; and a server configured to generate location information of each of the plurality of robotic transport vehicles and usage status information of each of the plurality of charging stations based on the GPS information and the current status information of the charging stations, respectively, generate selectable delivery order-related information among the delivery order-related information based on at least one of the generated location information and the usage status information, and transmit, to the user terminal device, the generated location information, the usage status information, and the selectable delivery order-related information to be displayed on the user terminal device.

The server may be configured to receive battery status information of each of the plurality of robotic transport vehicles, generate first selectable delivery order-related information based on the generated location information and the battery status information, and generate second selectable delivery order-related information based on the generated location information, the usage status information, and the battery status information.

The delivery order-related information may include information on a loading location of delivery goods, an unloading location of delivery goods, a delivery distance, a delivery request time, and a delivery status, and the usage status information of each of the

plurality of charging stations may include information on the location, availability, and price of each of the plurality of charging stations.

The server may be configured to generate, as the first selectable delivery order-related information, the delivery order-related information within a transportable range calculated based on the battery status information based on the generated location information.

The server may be configured to generate the second selectable delivery order-related information, based on the generated location information, based on the loading location of delivery goods, the unloading location of delivery goods, the battery status information, and the usage status information of each of the plurality of charging stations, and perform control to differently display the selectable delivery order-related information changing based on a selected order in consideration of a priority among charging of the robotic transport vehicle and driving for a delivery order.

The server may be configured to display detailed order-related information and a user interface for accepting or rejecting the order when a user touch input is input onto the selectable delivery order-related information displayed on the user terminal device.

The server may be configured to generate predictable delivery order-related information, based on an arrival point of the robotic transport vehicle driving for a current delivery order, based on an additional loading location of delivery goods for additional delivery order processing, an additional unloading location of delivery goods, battery status prediction information, and usage status prediction information of each of the plurality of charging stations, thereby making reservation for delivery order processing possible on the user terminal device.

According to an embodiment of the disclosure, provided is a control method of an operation system for a robotic transport vehicle, the method including: transmitting global

positioning system (GPS) information by a plurality of robotic transport vehicles; transmitting current status information of charging stations by the plurality of charging stations; displaying delivery order-related information by a user terminal device; generating location information of each of the plurality of robotic transport vehicles and usage status information of each of the plurality of charging stations by a server based on the GPS information and the current status information of the charging stations, respectively; generating selectable delivery order-related information among the delivery order-related information by the server based on at least one of the generated location information and the usage status information; and transmitting, to the user terminal device, the generated location information, the usage status information, and the selectable delivery order-related information by the server to be displayed on the user terminal device.

The method may further include: receiving battery status information of each of the plurality of robotic transport vehicles, wherein the generating of the selectable delivery order-related information includes generating first selectable delivery order-related information based on the generated location information and the battery status information, and generating second selectable delivery order-related information based on the generated location information, the usage status information, and the battery status information.

The delivery order-related information may include information on a loading location of delivery goods, an unloading location of delivery goods, a delivery distance, a delivery request time, and a delivery status, and the usage status information of each of the plurality of charging stations may include information on the location, availability, and price of each of the plurality of charging stations.

### BRIEF DESCRIPTION OF THE DRAWINGS

FIG. 1 is a block diagram illustrating a configuration of an operation system for a robotic transport vehicle according to an embodiment of the disclosure.

FIG. 2 is a diagram illustrating a vehicle location display process according to an embodiment of the disclosure.

FIG. 3 is a diagram illustrating a charging station and order location display process according to an embodiment of the disclosure.

FIGS. 4 to 7 are diagrams illustrating main codes for implementing vehicle location, delivery order information, charging station status, and data updating according to an embodiment of the disclosure.

FIG. 8 is a diagram illustrating an interface in which first selectable delivery order-related information is generated according to an embodiment of the disclosure.

FIGS. 9 and 10 are diagrams illustrating interfaces in which second selectable delivery order-related information is generated according to an embodiment of the disclosure.

FIG. 11 is a diagram illustrating an interface in which predictable delivery order-related information is generated according to an embodiment of the disclosure.

FIG. 12 is a flowchart illustrating a control method of an operation system for a robotic transport vehicle according to an embodiment of the disclosure.

FIG. 13 is a block diagram illustrating a detailed configuration of the operation system for a robotic transport vehicle illustrated in FIG. 1.

FIG. 14 is a diagram related to software modules stored in a storage unit according to an embodiment of the disclosure.

### DETAILED DESCRIPTION

Hereinafter, the disclosure will be described in more detail with reference to the accompanying drawings. In addition, in describing the disclosure, when it is determined that detailed descriptions of the known functions or configurations related to the disclosure may unnecessarily obscure the gist of the disclosure, such detailed descriptions will be omitted. In addition, terms described below are defined in consideration of functions in the disclosure, and may be construed in different ways by intentions of users or operators, practices, or the like. Therefore, the terms should be defined on the basis of the contents throughout the specification.

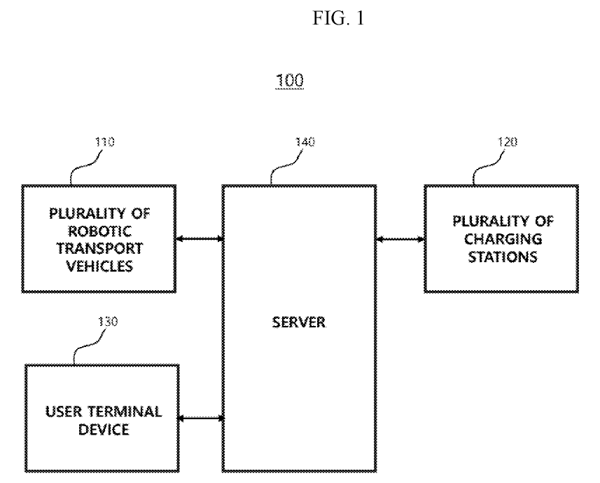

FIG. 1 is a block diagram illustrating a configuration of an operation system for a robotic transport vehicle according to an embodiment of the disclosure.

Referring to FIG. 1, an operation system 100 for a robotic transport vehicle according to an embodiment of the disclosure may include a plurality of robotic transport vehicles 110, a plurality of charging stations 120, a user terminal device 130, and a server 140.

Here, the operation system 100 for a robotic transport vehicle may be implemented as a combination or system including a plurality of components as described above, and may also be implemented as an algorithm for integratively managing and operating robotic transport vehicles. The operation system 100 may be implemented as a chip or a processor for executing such an algorithm or as software embedded in a device.

The plurality of robotic transport vehicles 110 may include autonomous-drivable unmanned transport vehicles of various forms and sizes, and each of the plurality of robotic transport vehicles 110 may transmit global positioning system (GPS) information at a predetermined period.

The robotic transport vehicle refers to a mobile robot or an autonomous vehicle equipped with artificial intelligence (AI), autonomous driving sensors, GPS, a

communication network, or the like, and capable of transporting and delivering goods by itself without human intervention. The robotic transport vehicle may drive within an urban area or a limited area for last-mile delivery, or may also perform long-distance delivery.

In addition, the plurality of charging stations 120 refer to facilities for supplying electricity to electric vehicles, and may charge a vehicle in a wired manner or a wireless manner. Each of the plurality of charging stations 120 may periodically transmit current status information of the charging station.

In addition, the user terminal device 130 may display delivery order-related information, and the delivery order-related information may be acquired from order information of users using a delivery-related application.

That is, when delivery orders of users are input through the delivery-related application installed in the user terminal device 130, the delivery order-related information may be displayed on the user terminal device 130.

Meanwhile, the server 140 may generate location information of each of the plurality of robotic transport vehicles 110 based on the GPS information transmitted from the plurality of robotic transport vehicles 110, and may generate usage status information of each of the plurality of charging stations 120 based on the current status information of charging stations transmitted from the plurality of charging stations 120.

In addition, the server 140 may generate selectable delivery order-related information among the delivery order-related information based on at least one of the generated location information of each of the plurality of robotic transport vehicles 110 and the usage status information of each of the plurality of charging stations 120, and may transmit, information to the user terminal device 130, the generated location information of each of the plurality of robotic transport vehicles 110, current status information of each of the plurality of charging stations 120, and selectable delivery order-related information to be integratively displayed on the user terminal device 130.

Specifically, the server 140 may display the current locations of the plurality of robotic transport vehicles on a map displayed on the user terminal device 130, and the number of current locations of the robotic transport vehicles displayed on the map may be changed based on a range of the displayed map.

In addition, when the user selects an object corresponding to the current location, in addition to the current locations of the plurality of robotic transport vehicles, the server 140 may display driving information of the selected robotic transport vehicle.

For example, when a user touch input is input to the object corresponding to the current location of the robotic transport vehicle, information such as the driving distance, driving speed, driving time, remaining battery amount, and battery efficiency of the robotic transport vehicle may be displayed.

In addition, the server 140 may display the usage status information of each of the plurality of charging stations 120 on the map displayed on the user terminal device 130 based on the current status information of each of the plurality of charging stations 120, and the number of current locations of the robotic transport vehicles displayed on the map may be changed based on the range of the displayed map.

In addition, the usage status information of each of the plurality of charging stations 120 displayed on the map may include the number of available charging devices among charging devices installed at each charging station, and colors of the objects respectively corresponding to the plurality of charging stations 120 displayed on the map may be displayed differently based on whether the number of available charging stations is equal to or greater than a predetermined value.

In addition, the server 140 may generate the selectable delivery order-related information among the delivery order-related information based on at least one of the generated location information of each of the plurality of robotic transport vehicles 110 and usage status information of each of the plurality of charging stations 120.

Specifically, the server 140 may generate the selectable delivery order-related information based on location information of one robotic transport vehicle. For example, the server 140 may generate loading locations at which delivery order requests are received and which are within a predetermined distance range from the current location of the robotic transport vehicle, or may generate loading locations at which delivery order requests are received and which are within a possible distance range based on the current location and remaining battery amount of the robotic transport vehicle.

In addition, the server 140 may generate the selectable delivery order-related information based on the location information of one robotic transport vehicle and the usage status information of each of the plurality of charging stations. For example, the server 140 may generate loading locations at which delivery order requests are received and which are within a possible distance range calculated in consideration of a movable range after moving from the current location of the robotic transport vehicle to the available charging station and charging, or may calculate a range of the available charging stations based on the current location and remaining battery amount of the robotic transport vehicle, and generate loading locations at which delivery order requests are received and which are within a distance range calculated in consideration of the movable range after charging of the vehicle based on a location of a charging station selected by the user within the calculated range.

In addition, the server 140 may select whether the robotic transport vehicle preferentially processes delivery orders or processes charging first, and may generate the selectable delivery order-related information based on driving routes based on each selection, battery status information, and usage status information of charging stations present on the driving routes.

In addition, the server 140 may transmit, to the user terminal device 130, the generated location information of the plurality of robotic transport vehicles 110, the usage status information of each of the plurality of charging stations 120, and the selectable delivery order-related information calculated as described above to be displayed as different objects on the user terminal device 130.

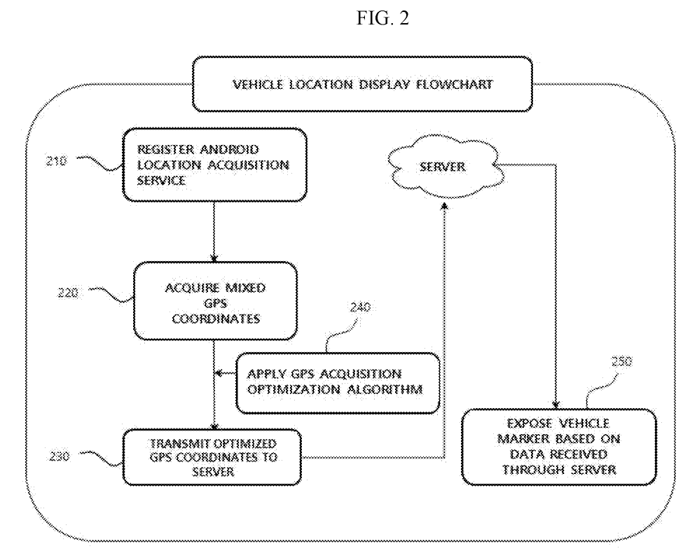

FIG. 2 is a diagram illustrating a vehicle location display process according to an embodiment of the disclosure.

Referring to FIG. 2, in the robotic transport vehicle location display process, when the robotic transport vehicle registers an Android location acquisition service (210), mixed GPS coordinates may be acquired through a GPS sensor (220), and optimized GPS coordinates may be transmitted to the server (230) by applying a GPS acquisition optimization algorithm (240).

In addition, the server may transmit the optimized GPS coordinate information to the user terminal device, and the user terminal device may display a vehicle marker (250) based on the received optimized GPS coordinate information.

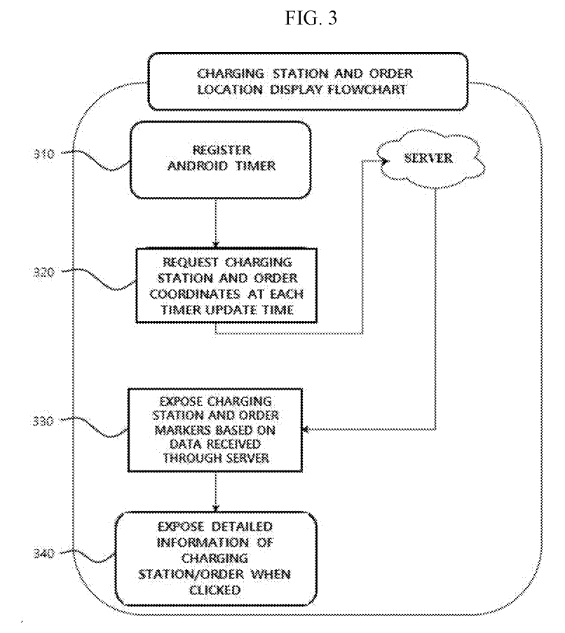

FIG. 3 is a diagram illustrating a charging station and order location display process according to an embodiment of the disclosure.

Referring to FIG. 3, in the charging station and delivery order location display process, the plurality of robotic transport vehicles and the plurality of charging stations may register an Android timer (310), and transmit the charging station and delivery order coordinates at each timer update time (320). The server may transmit the received charging station and delivery order coordinates to the user terminal device. The user terminal device may display the charging station and delivery order markers (330), and display detailed information of the charging station or the delivery order (340) when the user clicks the charging station and delivery order markers.

Here, the server may request the charging station and delivery order coordinates from the plurality of robotic transport vehicles and the plurality of charging stations at each timer update time.

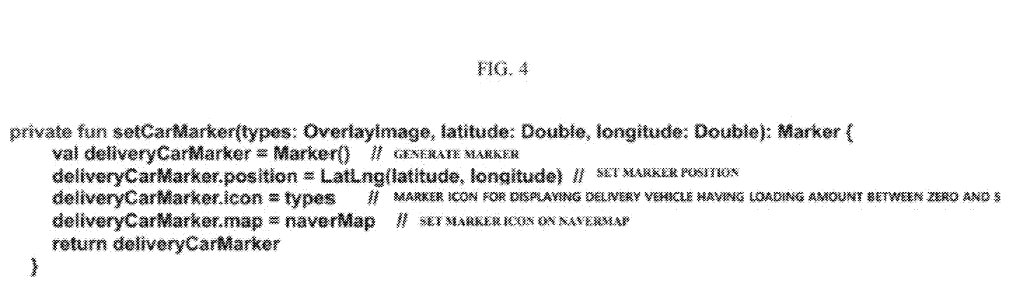

FIGS. 4 to 7 are diagrams illustrating main codes for implementing vehicle location, delivery order information, charging station status, and data updating according to an embodiment of the disclosure.

FIG. 4 illustrates main codes for generating vehicle location markers, and the main codes refer to the codes for generating a marker related to the current location of the vehicle, setting a marker position, generating a marker icon for displaying a delivery vehicle having a loading amount between zero and 5, and displaying the marker icon on a map.

That is, the codes illustrated in FIG. 4 do not merely generate and display a marker for only the current location of the robotic transport vehicle, but generate and display, on the map, marker icons only for the robotic transport vehicles falling within a limited range of loading amounts, which is intended to display only robotic transport vehicles capable of additional loading.

Accordingly, filtering of robotic transport vehicles displayable on the map may be performed based on a range of loading amounts.

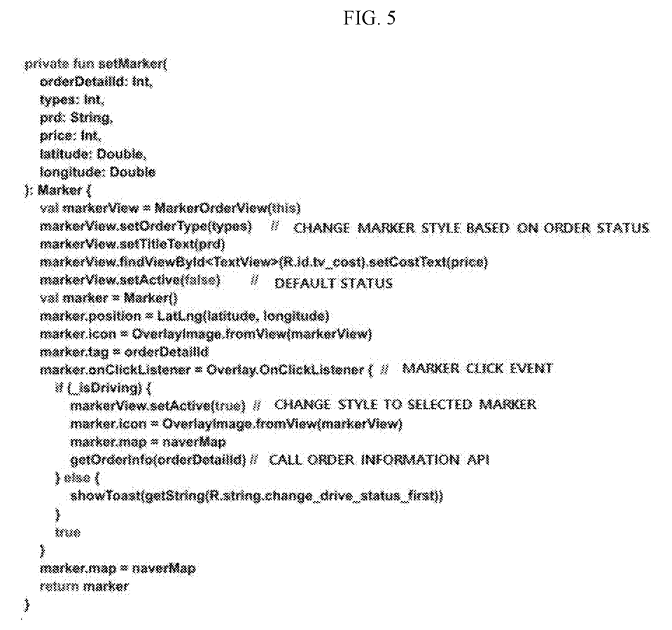

In addition, FIG. 5 illustrates main codes for generating delivery order-related markers, and the main codes refer to codes for changing a marker style based on an order status, for example, codes for changing the color, shape, size, or the like of a marker based on whether an order is currently reserved or an order processing is in progress. The main codes may include codes related to occurrence of a marker click event, codes for customizing a marker by changing a style to a selected marker, and codes for calling an order information-related application programming interface (API) for displaying detailed order information.

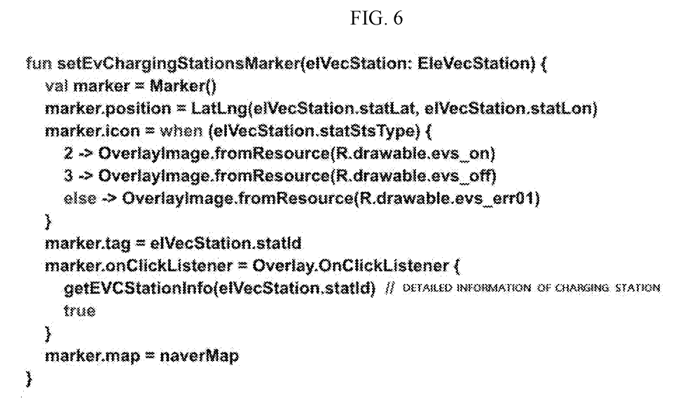

In addition, FIG. 6 illustrates main codes for generating charging station location-related markers, and the main codes may include codes for displaying detailed information of the charging station.

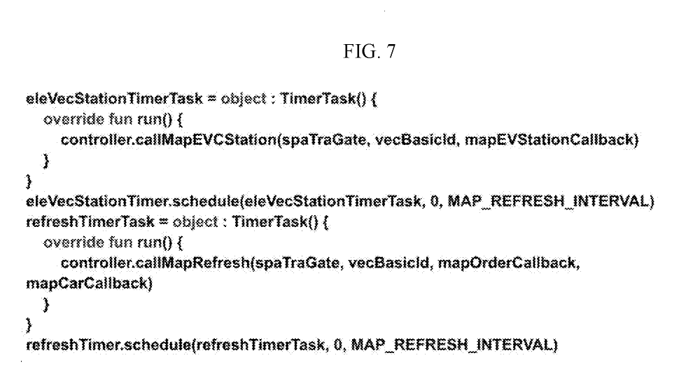

In addition, FIG. 7 illustrates codes for periodically updating the delivery order information and usage status information of charging stations.

Meanwhile, the server 140 may receive the battery status information of each of the plurality of robotic transport vehicles 110, and may generate first selectable delivery order-related information based on the generated location information and the battery status information.

Specifically, the server 140 may calculate a movable distance of the robotic transport vehicle based on the remaining battery amount among the battery status information. Accordingly, the server 140 may generate the first selectable delivery order-related information present within a movable distance range among the plurality of delivery order-related information in consideration of the generated location information of the robotic transport vehicle and the battery status information, that is, the movable distance calculated based on the current location of the robotic transport vehicle.

In addition, the server 140 may generate second selectable delivery order-related information based on the generated location information, the usage status information, and the battery status information.

Specifically, the server 140 may calculate the movable distance based on the remaining battery amount among the battery status information with reference to the current location of the robotic transport vehicle, select one chargeable charging station

among the plurality of charging stations within the calculated movable distance range, and generate the second selectable delivery order-related information present within the movable distance range among the plurality of delivery order-related information in consideration of the movable distance after full charging based on a location of the selected charging station.

Here, the delivery order-related information may include information on a loading location of delivery goods, an unloading location of delivery goods, a delivery distance, a delivery request time, and a delivery status.

For example, the loading location of delivery goods refers to a location at which delivery goods are loaded according to the received delivery request, the unloading location of delivery goods refers to a location at which delivery goods are unloaded according to the received delivery request, the delivery request time refers to a delivery start time or a delivery completion time, and the delivery status refers to whether delivery is currently in progress.

In addition, the usage status information of each of the plurality of charging stations 120 may include information on the location, availability, and price of each of the plurality of charging stations 120.

In addition, the server 140 may generate, as the first selectable delivery order-related information, the delivery order-related information within a transportable range calculated based on the battery status information based on the generated location information of the robotic transport vehicle.

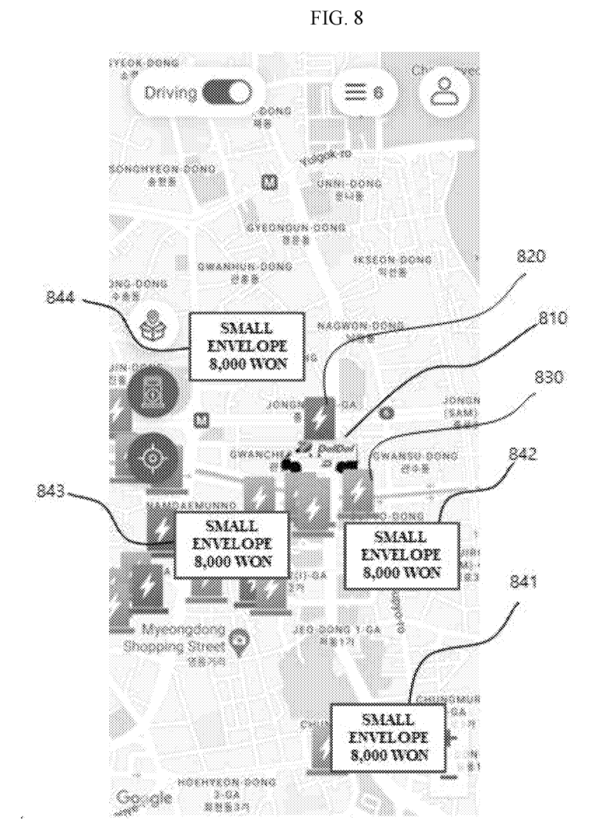

FIG. 8 is a diagram illustrating an interface in which the first selectable delivery order-related information is generated according to an embodiment of the disclosure.

Referring to FIG. 8, a current location 810 of the robotic transport vehicle is displayed on a map, and the server 140 may generate, as the first selectable delivery order- related information, delivery order-related information 841, 843, and 844 within the transportable range calculated based on the battery status information of the robotic transport vehicle, particularly the remaining battery amount.

In addition, the usage status information of the plurality of charging stations located around the current location 810 of the robotic transport vehicle is displayed on the map, and among the plurality of charging stations, an available charging station 830 is displayed in green, and a charging station 820 that is unavailable due to a large number of vehicles using charging is displayed in blue. In this way, the respective charging stations are displayed differently based on their usage statuses.

Meanwhile, the server 140 may generate the second selectable delivery order-related information, based on the generated location information, based on the loading location of delivery goods, the unloading location of delivery goods, the battery status information, and the usage status information of each of the plurality of charging stations, and may perform control to differently display the selectable delivery order-related information changing based on a selected order in consideration of a priority among charging of the robotic transport vehicle and driving for the delivery order.

That is, the server 140 may generate the second selectable delivery order-related information in consideration of the loading location of goods to be delivered, the unloading location of goods to be delivered, the remaining battery amount, and a usage status of each of surrounding charging stations, based on the generated current location of the robotic transport vehicle, and the second selectable delivery order-related information may also be changed based on whether charging the robotic transport vehicle or driving for a delivery order is prioritized.

Specifically, the server 140 may set a priority to determine whether to charge the robotic transport vehicle first and then receive a delivery order and proceed with driving, or to receive a delivery order, proceed with driving, and then perform charging. The movable distance range based on the current location of the robotic transport vehicle is changed based on a selected order corresponding to the determined priority, and may thus also change the selectable delivery order-related information.

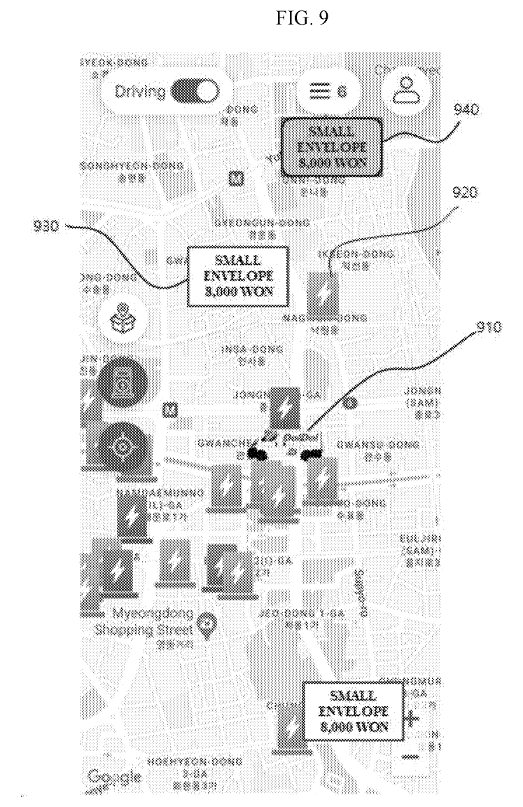

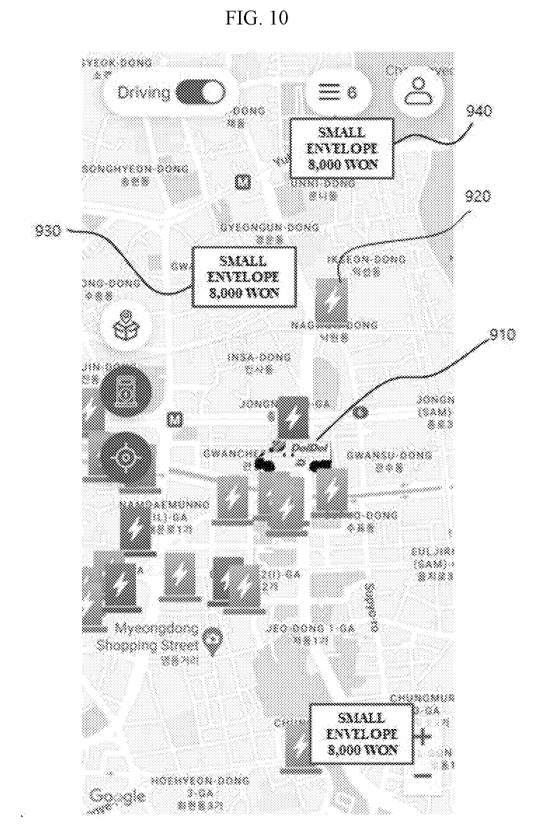

FIGS. 9 and 10 are diagrams illustrating interfaces in which the second selectable delivery order-related information is generated according to an embodiment of the disclosure.

Referring to FIG. 9, assuming a case in which driving is performed after receiving a delivery order and then charging is performed, the server 140 may detect a charging station 920 located on a route along which the robotic transport vehicle drives from a current location 910 through a loading location 930 of delivery goods to an unloading location of delivery goods, and when a driving distance from the current location 910 of the robotic transport vehicle to the loading location 930 of delivery goods and then to the charging station 920 is within the movable distance range possible with a current remaining battery amount of the robotic transport vehicle, the delivery order-related information generated at the loading location 930 of delivery goods may be generated as the second selectable delivery order-related information and displayed on the map.

Meanwhile, the server 140 may detect the charging station 920 located on a route along which the robotic transport vehicle drives from the current location 910 through another loading location 940 of delivery goods to the unloading location of delivery goods. However, when a driving distance from the current location 910 of the robotic transport vehicle to another loading location 930 of delivery goods and then to the charging station 920 exceeds the movable distance range possible with the current remaining battery amount of the robotic transport vehicle, the delivery order-related information generated at the other loading location 940 of delivery goods may be displayed in red and displayed as an unselectable order.

Referring to FIG. 10, assuming a case in which charging is performed first and then driving is performed after a delivery order is received, the server 140 may detect the charging station 920 present within the movable distance range possible with the remaining battery amount from the current location 910 of the robotic transport vehicle, and may generate and display the delivery order-related information corresponding to the loading locations 930 and 940 of delivery goods within the movable distance range possible after full charging of the robotic transport vehicle based on a location of the charging station 920, and referring to FIG. 10, it may be confirmed that objects corresponding to the loading locations 930 and 940 of delivery goods are displayed as selectable orders without being displayed in red, unlike FIG. 9.

Meanwhile, the server 140 may display detailed order-related information and a user interface for accepting or rejecting the order when the user touch input is input onto the selectable delivery order-related information displayed on the user terminal device 130.

Specifically, when the user touch is input onto any one of the objects corresponding to the loading locations 930 and 940 of delivery goods displayed as the selectable orders as illustrated in FIG. 10, the server 140 may display the detailed order-related information, for example, the type, weight, size, destination, distance to the destination, and delivery cost of ordered goods, and may also display a user interface or a graphical user interface for selecting whether to accept or reject the delivery order based on such detailed information.

Meanwhile, the server 140 may generate predictable delivery order-related information, based on an arrival point of the robotic transport vehicle driving for a current delivery order, based on an additional loading location of delivery goods for additional delivery order processing, an additional unloading location of delivery goods, battery status prediction information, and usage status prediction information of each of the plurality of charging stations, thereby making reservation for delivery order processing possible on the user terminal device 130.

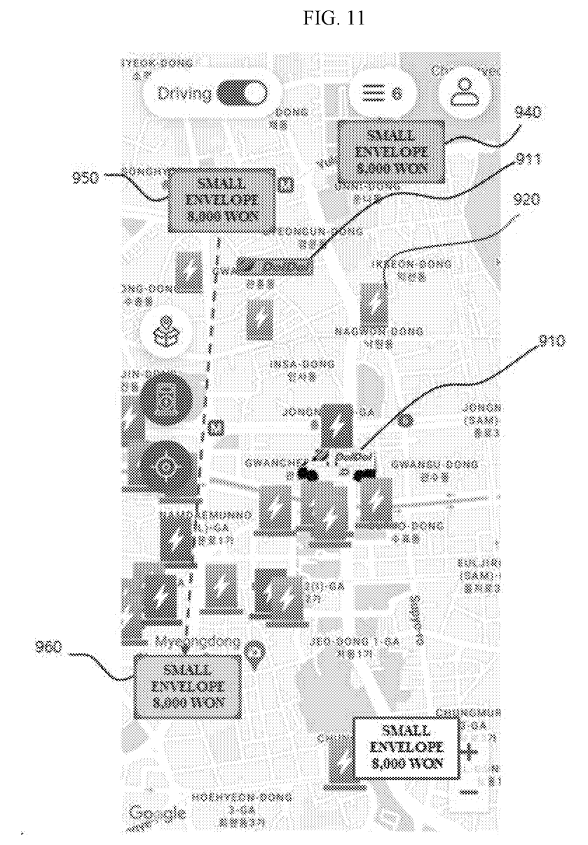

FIG. 11 is a diagram illustrating an interface in which the predictable delivery order-related information is generated according to an embodiment of the disclosure.

Referring to FIG. 11, the server 140 may calculate an arrival point 911 of the robotic transport vehicle driving to process a current delivery order based on detailed information of the current delivery order, and may enable reservation for additional delivery order processing based on the arrival point 911.

For example, the server 140 may identify a predictable additional delivery order loading location 950 and a predictable additional delivery order unloading location 960 based on the arrival point 911 of the robotic transport vehicle, calculate a predicted driving distance from the current location 910 of the robotic transport vehicle through the arrival point 911 and the predictable additional delivery order loading location 950 to the predictable additional delivery order unloading location 960, and predict a battery consumption amount in a case in which the robotic transport vehicle drives the calculated predicted driving distance, thereby calculating battery status prediction information.

In addition, the server 140 may calculate usage status prediction information of each of the plurality of charging stations for a corresponding region and time based on the usage status information of each of the plurality of charging stations acquired for each region and time.

In addition, the server 140 may display the predictable delivery order-related information, that is, the predictable delivery order loading location 950, on the map based on a predicted driving distance from the current location 910 of the robotic transport vehicle through the arrival point 911 and the predictable additional delivery order loading location 950 to the predictable additional delivery order unloading location 960, the battery status prediction information acquired by predicting the battery consumption amount in a case in which the robotic transport vehicle drives the calculated predicted driving distance, and the usage status prediction information of each of the plurality of charging stations for the corresponding region and time.

Meanwhile, objects corresponding to the predictable additional delivery order loading and unloading locations 950 and 960 may be displayed in blue as illustrated in FIG. 10, and when the user touch is input onto the displayed object, a user interface for accepting or rejecting a predicted delivery order may be displayed.

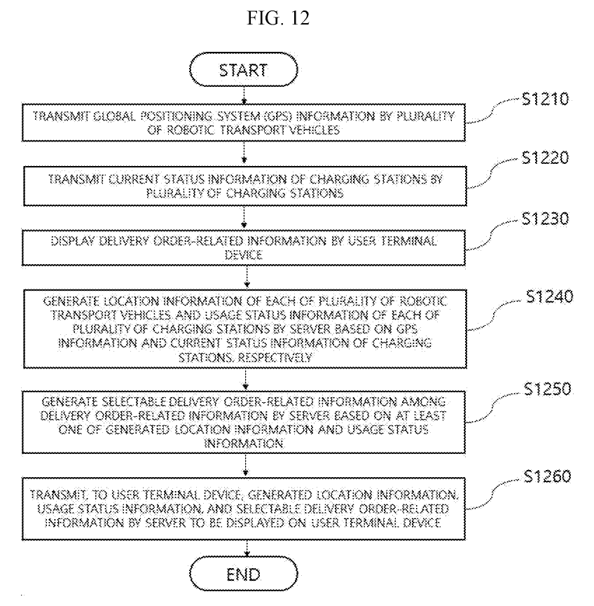

FIG. 12 is a flowchart illustrating a control method of an operation system for a robotic transport vehicle according to an embodiment of the disclosure.

Referring to FIG. 12, the control method of an operation system for a robotic transport vehicle according to an embodiment of the disclosure may include: transmitting global positioning system (GPS) information by a plurality of robotic transport vehicles (S1210); transmitting current status information of charging stations by the plurality of charging stations (S1220); displaying delivery order-related information by a user terminal device (S1230); generating location information of each of the plurality of robotic transport vehicles and usage status information of each of the plurality of charging stations by a server based on the GPS information and the current status information of the charging stations, respectively (S1240); generating selectable delivery order-related information among the delivery order-related information by the server based on at least one of the generated location information and the usage status information (S1250); and transmitting, to the user terminal device, the generated location information, the usage status information, and the selectable delivery order-related information by the server to be displayed on the user terminal device (S1260).

In addition, the control method of an operation system for a robotic transport vehicle according to an embodiment of the disclosure may further include: receiving battery status information of each of the plurality of robotic transport vehicles, and the generating of the selectable delivery order-related information (S1250) may include generating first selectable delivery order-related information based on the generated location information and the battery status information, and generating second selectable delivery order-related information based on the generated location information, the usage status information, and the battery status information.

In addition, the delivery order-related information may include information on a loading location of delivery goods, an unloading location of delivery goods, a delivery distance, a delivery request time, and a delivery status, and the usage status information of each of the plurality of charging stations may include information on the location, availability, and price of each of the plurality of charging stations.

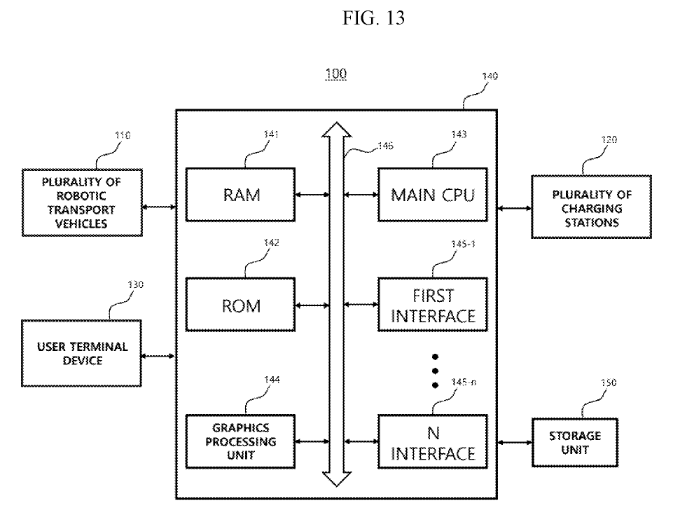

FIG. 13 is a block diagram illustrating a detailed configuration of the operation system for a robotic transport vehicle illustrated in FIG. 1.

Referring to FIG. 13, the operation system 100 for a robotic transport vehicle may include the plurality of robotic transport vehicles 110, the plurality of charging stations 120, the user terminal device 130, the server 140, and a storage unit 150.

The server 140 may control overall operations of the operation system 100 for a robotic transport vehicle.

Specifically, the server 140 may include a random access memory (RAM) 141, a read only memory (ROM) 142, a main central processing unit (CPU) 143, a graphics processing unit 144, first to n interfaces 145-1 to 145-n, and a bus 146.

The RAM 141, the ROM 142, the main CPU 143, the graphics processing unit 144, the first to n interfaces 145-1 to 145-n, and the like may be connected to each other through the bus 146.

The first to n interfaces 145-1 to 145-n may be connected to the various components described above, and one of the interfaces may be implemented as a network interface connected to an external device through a network.

The main CPU 143 may access the storage unit 150 and perform booting by using an operating system (O/S) stored in the storage unit 150, and perform various operations by using various programs, contents, and data stored in the storage unit 150.

In particular, the main CPU 143 may generate the location information of each of the plurality of robotic transport vehicles and the usage status information of each of the plurality of charging stations based on the GPS information and current status information of the charging stations, generate the selectable delivery order-related information among the delivery order-related information based on at least one of the generated location information and the usage status information, and transmit, to the user terminal device, the generated location information, the usage status information, and the selectable delivery order-related information to be displayed on the user terminal device.

The ROM 142 may store an instruction set for system booting. When a turn-on command is input and power is supplied, the main CPU 143 may copy the O/S stored in the storage unit 150 to the RAM 141 according to the instructions stored in the ROM 142 and execute the O/S to boot the system. After booting is completed, the main CPU 143 may copy various application programs stored in the storage unit 150 to the RAM 141 and execute the application programs copied to the RAM 141 to perform various operations.

The graphics processing unit 144 may generate a screen including various objects such as icons, images, and texts by using a calculation unit (not shown) and a rendering unit (not shown). The calculation unit (not shown) may calculate attribute values such as coordinate values, shapes, sizes, and colors at which respective objects are to be displayed according to a layout of the screen based on received control commands. The rendering unit (not shown) may generate screens having various layouts including objects based on the attribute values calculated by the calculation unit (not shown).

In particular, the graphics processing unit 144 may implement the objects generated by the main CPU 143 as a graphical user interface (GUI), icons, or user interface screens.

Meanwhile, operations of the server 140 described above may be performed by the programs stored in the storage unit 150.

The storage unit 150 may store an operating system (O/S) software module for driving the operation system 100 for a robotic transport vehicle, and various data such as various multimedia contents.

In particular, the storage unit 150 may include a software module for generating the location information of each of the plurality of robotic transport vehicles and the usage status information of each of the plurality of charging stations based on the GPS information and the current status information of the charging stations, generating the selectable delivery order-related information among the delivery order-related information based on at least one of the generated location information and the usage status information, and transmitting, to the user terminal device, the generated location information, the usage status information, and the selectable delivery order-related information to be displayed on the user terminal device.

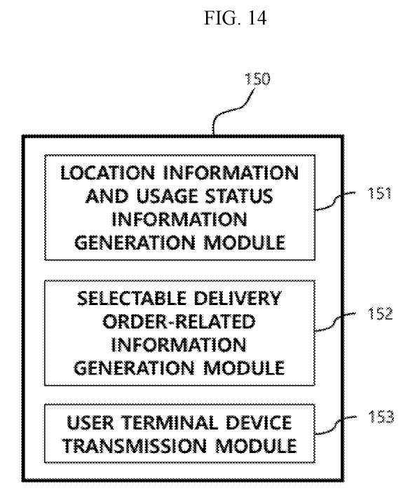

FIG. 14 is a diagram illustrating the software module stored in the storage unit according to an embodiment of the disclosure.

Referring to FIG. 14, the storage unit 150 may store programs such as a location information and usage status information generation module 151, a selectable delivery order-related information generation module 152, and a user terminal device transmission module 153.

Meanwhile, operations of the server 140 described above may be performed by the programs stored in the storage unit 150. Hereinafter, detailed operations of the server 140 performed using the programs stored in the storage unit 150 are described in detail.

The location information and usage status information generation module 151 may generate the location information of each of the plurality of robotic transport vehicles and the usage status information of each of the plurality of charging stations based on the GPS information of each of the plurality of robotic transport vehicles and the current status information of each of the plurality of charging stations.

In addition, the selectable delivery order-related information generation module 152 may generate the selectable delivery order-related information among the delivery order-related information based on at least one of the generated location information and the usage status information.

In addition, the user terminal device transmission module 153 may transmit, to the user terminal device, the generated location information, the usage status information, and the selectable delivery order-related information to be displayed on the user terminal device.

Meanwhile, a non-transitory computer readable medium in which a program for sequentially performing the control method according to the disclosure is stored may be provided.

The non-transitory computer readable medium refers to a medium that semi-permanently stores data rather than temporarily storing data, such as a register, a cache, or a memory, and is readable by a device. Specifically, the various applications or programs described above may be stored and provided in the non-transitory computer readable medium such as a compact disc (CD), a digital versatile disc (DVD), a hard disk, a Blu-ray disc, a universal serial bus (USB), a memory card, or a read only memory (ROM).

In addition, although the bus is not illustrated in the above-described block diagrams illustrating the operation system for a robotic transport vehicle, operation system for a robotic transport vehicle may further include a processor such as a CPU or a microprocessor that generates the location information of each of the plurality of robotic transport vehicles and the usage status information of each of the plurality of charging stations based on the GPS information and the current status information of the charging stations, generates the selectable delivery order-related information among the delivery order-related information based on at least one of the generated location information and the usage status information, and transmits, to the user terminal device, the generated location information, the usage status information, and the selectable delivery order-related information to be displayed on the user terminal device.

According to the various embodiments of the disclosure as described above, the current locations of the robotic transport vehicles, the delivery routes, the charging station statuses, and the delivery order-related information may be integratively managed on a single map, thereby increasing user convenience.

In addition, although the preferred embodiments according to the disclosure are illustrated and described as above, the disclosure is not limited to the above-described specific embodiments, and may be variously modified by those skilled in the art to which the disclosure pertains without departing from the scope of the disclosure as claimed in the accompanying claims. These modifications should also be understood to fall within the spirit of the disclosure.

What is claimed is:

1. An operation system for a robotic transport vehicle, the operation system comprising:
a plurality of robotic transport vehicles configured to transmit global positioning system (GPS) information;
a plurality of charging stations configured to transmit current status information of charging stations;
a user terminal device configured to display delivery order-related information; and
a server configured to:
generate location information of each of the plurality of robotic transport vehicles and usage status information of each of the plurality of charging stations based on the GPS information and the current status information of the charging stations, respectively;
generate selectable delivery order-related information among the delivery order-related information based on at least one of the generated location information and the usage status information; and
transmit, to the user terminal device, the generated location information, the usage status information, and the selectable delivery order-related information to be displayed on the user terminal device.

2. The operation system as claimed in claim 1, wherein the server is configured to:
receive battery status information of each of the plurality of robotic transport vehicles;
generate first selectable delivery order-related information based on the generated location information and the battery status information; and
generate second selectable delivery order-related information based on the generated location information, the usage status information, and the battery status information.

3. The operation system as claimed in claim 2, wherein the delivery order-related information includes information on a loading location of delivery goods, an unloading location of delivery goods, a delivery distance, a delivery request time, and a delivery status, and
the usage status information of each of the plurality of charging stations includes information on the location, availability, and price of each of the plurality of charging stations.

4. The operation system as claimed in claim 3, wherein the server is configured to generate, as the first selectable delivery order-related information, the delivery order-related information within a transportable range calculated based on the battery status information based on the generated location information.

5. The operation system as claimed in claim 4, wherein the server is configured to:
generate the second selectable delivery order-related information, based on the generated location information, based on the loading location of delivery goods, the unloading location of delivery goods, the battery status information, and the usage status information of each of the plurality of charging stations; and
perform control to differently display the selectable delivery order-related information changing based on a selected order in consideration of a priority among charging of the robotic transport vehicle and driving for a delivery order.

6. The operation system as claimed in claim 5, wherein the server is configured to display detailed order-related information and a user interface for accepting or rejecting the order when a user touch input is input onto the selectable delivery order-related information displayed on the user terminal device.

7. The operation system as claimed in claim 6, wherein the server is configured to generate predictable delivery order-related information, based on an arrival point of the robotic transport vehicle driving for a current delivery order, based on an additional loading location of delivery goods for additional delivery order processing, an additional unloading location of delivery goods, battery status prediction information, and usage status prediction information of each of the plurality of charging stations, thereby making reservation for delivery order processing possible on the user terminal device.

8. A control method of an operation system for a robotic transport vehicle, the control method comprising:
transmitting global positioning system (GPS) information by a plurality of robotic transport vehicles;
transmitting current status information of charging stations by the plurality of charging stations;
displaying delivery order-related information by a user terminal device;
generating location information of each of the plurality of robotic transport vehicles and usage status information of each of the plurality of charging stations by a server based on the GPS information and the current status information of the charging stations, respectively;
generating selectable delivery order-related information among the delivery order-related information by the server based on at least one of the generated location information and the usage status information; and
transmitting, to the user terminal device, the generated location information, the usage status information, and the selectable delivery order-related information by the server to be displayed on the user terminal device.

9. The method as claimed in claim 8, further comprising:
receiving battery status information of each of the plurality of robotic transport vehicles,
wherein the generating of the selectable delivery order-related information includes:
generating first selectable delivery order-related information based on the generated location information and the battery status information; and
generating second selectable delivery order-related information based on the generated location information, the usage status information, and the battery status information.

10. The method as claimed in claim 9, wherein the delivery order-related information includes information on a loading location of delivery goods, an unloading location of delivery goods, a delivery distance, a delivery request time, and a delivery status, and
the usage status information of each of the plurality of charging stations includes information on the location, availability, and price of each of the plurality of charging stations.
